(19) United States
(12) Patent Application Publication
(10) Pub. No.: US 2021/0328248 A1
(43) Pub. Date: Oct. 21, 2021

(54) CONTAINER TYPE POWER GENERATION FUEL CELL SYSTEM

(71) Applicants: Hyundai Motor Company, Seoul (KR); Kia Motors Corporation, Seoul (KR)

(72) Inventors: Jun Seok SEO, Gunpo-si (KR); Jung Tak KANG, Gunpo-si (KR); Yong Doo SON, Incheon (KR)

(73) Assignees: Hyundai Motor Company, Seoul (KR); Kia Motors Corporation, Seoul (KR)

(21) Appl. No.: 17/010,131

(22) Filed: Sep. 2, 2020

(30) Foreign Application Priority Data
Apr. 21, 2020 (KR) 10-2020-0048185

(51) Int. Cl. H01M 8/2475; H01M 8/249; H01M 8/04082; H01M 8/04029; H01M 8/04858; H01M 8/04701

(52) U.S. Cl. CPC H01M 8/2475; H01M 8/249; H01M 8/04201; H01M 2250/20; H01M 8/0488; H01M 8/04701; H01M 8/04029

(57) ABSTRACT

A container type power generation fuel cell system may include a container having a door in one side or both sides; a plurality of stack modules mounted in the container and each having fuel cell stacks stacked and separately connected to each other in an attachable/detachable manner; a fuel supply line connected to a fuel supply outside the container, inserted into the container, and connected to the fuel cell stacks to supply hydrogen and air that are fuel gases; an exhaust line forming a channel through which exhaust gas produced by the fuel cell stacks flows to discharge the exhaust gas outside the container; a cooling fluid circulation line connected to the fuel cell stacks to exchange heat and passing cooling fluid therethrough; and a power converter converting DC voltage produced by the stack modules into AC voltage, in which the stack modules may be integrally managed.

### CROSS REFERENCE TO RELATED APPLICATION

The present application claims priority to Korean Patent Application No. 10-2020-0048185, filed on Apr. 21, 2020, the entire contents of which is incorporated herein for all purposes by this reference.

### BACKGROUND OF THE INVENTION

### Field of the Invention

The present invention relates to a container type power generation fuel cell system that can generate a large amount of power by stacking fuel cell stacks to configure a stack module and constructing a container to be able to integrally manage several stack modules.

### Description of Related Art

In the large-scale power generation generally, power is usually generated using electromagnetic induction by mechanical torque. However, there is a problem of a loss of energy and environment contamination due to byproducts in a process of energy conversion.

A fuel cell power generation system is highlighted as the next-generation energy conversion apparatus to solve the present problem. A fuel cell is an energy conversion device using hydrogen as the main energy source to replace the fossil fuel. The fuel cell provides high energy conversion efficiency, is eco-friendly because it does not produce harmful substances, and is free from the problem of energy exhaustion because oxygen and hydrogen that are the energy sources are infinite.

A fuel cell system for power generation can be installed in various scales and can provide electricity and heat. In generally, a fuel cell for power generation means a power generator that has an output of 25 kW or more and is operated in an apparatus type. To use an automotive fuel cell for power generation, a facility including a fuel supply, a cooler, a power converter, a controller, etc. is separately required.

There is a large possibility of deterioration in performance of an automotive fuel cell because vehicles are driven under various environments, and such an automotive fuel cell is difficult to use for a vehicle when the performance drops below a predetermined level. Therefore, it is required to construct a system that can use such an automotive fuel cell as a fuel cell for power generation.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a system that can generate various amounts of power, if necessary, and may be use an automotive fuel cell as a fuel cell for power generation by including several stack modules each formed by stacking fuel cell stacks.

In view of the above aspects, various aspects of the present invention provide a container type power generation fuel cell system including: a container having a door in one side or both sides; a plurality of stack modules mounted in the container and each having fuel cell stacks stacked and separately connected to each other in an attachable/detachable manner; a fuel supply line connected to a fuel supply outside the container, inserted into the container, and connected to the fuel cell stacks to supply hydrogen and air that are fuel gases; an exhaust line forming a channel through which exhaust gas produced by the fuel cell stacks flows to discharge the exhaust gas outside the container; a cooling fluid circulation line connected to the fuel cell stacks to exchange heat and passing cooling fluid therethrough; and a power converter converting DC voltage produced by the stack modules into AC voltage, in which the stack modules may be integrally managed.

The fuel cell stack may be an automotive fuel cell powertrain.

The stack module may have a frame in which the fuel cell stacks may be stacked, and the frames may be connected to each other.

The fuel cell stacks may be connected in series to each other and the stack modules may be connected in parallel to each other.

The container type power generation fuel cell system may further include a controller electrically connected to the stack modules, the fuel supply line, the cooling fluid circulation line, and the power converter to detect states and control operations thereof, and selectively controlling the stack modules.

The controller may be connected to one or more containers and may integrally control a plurality of containers.

The cooling fluid circulation line may include an expansion tank that maintains pressure of cooling fluid at a predetermined level.

An anti-explosion fan conditioning air in the container may be mounted outside the container.

The fuel supply line may include a hydrogen supply line for supplying hydrogen to the fuel cell stacks and an air supply line, and a valve controlling a flow rate of hydrogen may be mounted in the hydrogen supply line.

The air supply line may include a blower sending air into the fuel cell stack.

A heat exchanger for cooling the cooling fluid may be mounted in the cooling fluid circulation line.

The container type power generation fuel cell system may further include a terminal block mounted in the container, connecting different wires, and determining paths of the wire.

According to the container type power generation fuel cell system of the present invention, all of components are mounted and appropriately mounted in a limited area, so it is possible to construct a system that can stably produce power.

Since an anti-explosion structure for removing the danger of explosion due to hydrogen is provided, the stability is excellent.

An automotive fuel cell may be used as a power generation fuel cell, and it is possible to secure additional life span of a fuel cell by use of an automotive fuel cell which is dead.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a container type power generation fuel cell system according to various exemplary embodiments of the present invention;

FIG. 2 is a perspective view of a stack module of the container type power generation fuel cell system according to various exemplary embodiments of the present invention;

FIG. 3 and FIG. 4 are views showing the inside of a container of the container type power generation fuel cell system according to various exemplary embodiments of the present invention; and

FIG. 5 is a view showing the connection relationship in the container type power generation fuel cell system according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent portions of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

A specific structural or functional description of embodiments of the present invention included in the specification or application is provided merely for describing the exemplary embodiment according to various exemplary embodiments of the present invention. Therefore, the exemplary embodiments according to various exemplary embodiments of the present invention may be implemented in various forms, and the present invention may not be construed as being limited to the exemplary embodiments described in the specification or application.

Various changes and modifications may be made to the exemplary embodiments according to various exemplary embodiments of the present invention, and therefore various exemplary embodiments will be illustrated in the drawings and described in the specification or application. However, it may be understood that embodiments according to the concept of the present invention are not limited to the particular disclosed exemplary embodiments of the present invention, but the present invention includes all modifications, equivalents, and alternatives falling within the spirit and scope of the present invention.

The present invention will be described hereafter in detail by describing exemplary embodiments of the present invention with reference to the accompanying drawings. Like reference numerals given in the drawings indicate like components.

The present invention relates to a container type power generation fuel cell system including fuel cell stacks 210 connected to each other in a container 100 to be configured to generate a large amount of power.

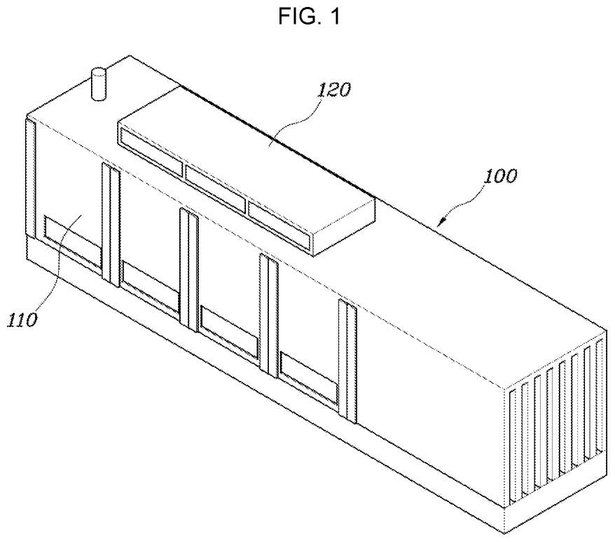

FIG. 1 is a perspective view of a container type power generation fuel cell system according to various exemplary embodiments of the present invention. Referring to FIG. 1, a container type power generation fuel cell system according to various exemplary embodiments of the present invention includes a container 100 and components for power generation are mounted therein, so integral management is possible.

A door 110 which may be opened and close may be formed in one side or both sides of the container 100. It is possible to enter the container 100 by opening the door 110 and to stably operate the system by closing the door 110.

An anti-explosion fan 120 may be mounted on a side of the container 100. The anti-explosion fan 120 can condition the air in the container 100. The anti-explosion fan may include a fan and a motor having sufficient capacity to be configured to remove the danger of explosion inside the container 100.

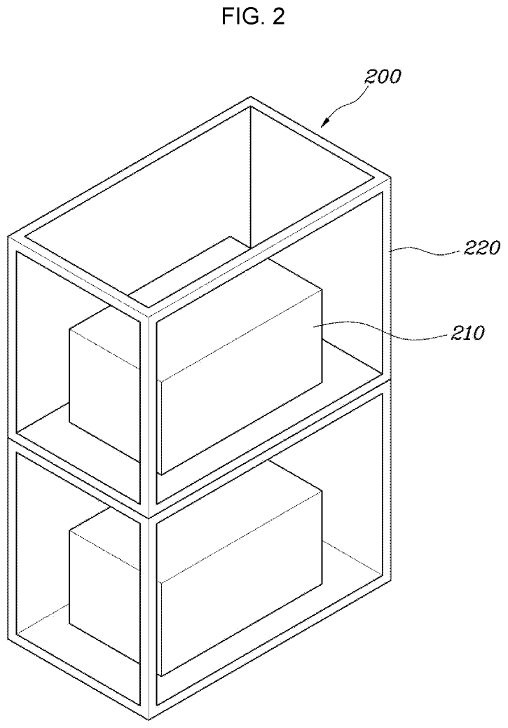

FIG. 2 is a perspective view of a stack module 200 of the container type power generation fuel cell system according to various exemplary embodiments of the present invention. FIG. 2 is a view conceptually showing the stack module 200, in which other components are not shown and the present invention is not limited to the detailed structure shown in the figure.

The stack module 200 is a power generation device in the container 100 and is the minimum power generation unit. Fuel cell stacks 210 are stacked in the stack module 200 and the stack module 200 is mounted in the container 100 and can produce electricity and water. The fuel cell stack 210 may include an anode, a cathode, and an electrolyte layer, and can receive hydrogen and air, which are fuel gases, and produce electricity, water, and heat. The reactions that are generated at the anode and the cathode of the fuel cell stack 210 are expressed as follows.

$$[ Chemical equation at anode ] {H}_{2} \to 2 {H}^{+} + 2 {e}^{-} \\ [ Chemical equation at the cathode ] 1 / 2 {O}_{2} + 2 H + + 2 {e}^{-} \to {H}_{2} O \\ [ Entire chemical equation ] H2 + 1 / 2 {O}_{2} \to {H}_{2} O$$

Hydrogen and oxygen that are the reactants for producing electricity and thermal energy in the stack module 200 are defined and referred to as fuel gases in various exemplary embodiments of the present invention. As for oxygen, not pure oxygen, but atmospheric air is supplied to the stack module 200 and the oxygen in the air is used as a reactant. Pure oxygen can increase the efficiency of a fuel cell system, but storing oxygen increases the cost and weight. Accordingly, since a lot of oxygen is included in the air, so that the air is supplied.

The fuel cell stacks 210 of the stack module 200, as shown in FIG. 2, may be connected to each other in a stacked structure. The stack module 200 may have a frame 220 on which the fuel cell stacks 210 may be stacked. The fuel cell stack 210 is mounted in each floor of the frame 220 and the fuel cell stacks 210 are connected, whereby the stack module 200 may be configured. The fuel cell stacks 210 may be separably connected in an attachable/detachable manner, so they may be easily separated from the frame 220. Accordingly, when the fuel cell stack 210 ages or dies, it may be separated and replaced, which results in an effect in which the entire system is easily managed.

The fuel cell stacks 210 of the stack module 200 may be electrically connected in series to each other. That is, the fuel cell stacks 210 are stacked and directly connected to each other inside the frame 220, whereby one stack module 220 is formed. Since the fuel cell stacks 210 are stacked in series, the possible potential difference increases, so that the total power generation capacity may be increased.

The fuel cell stack 210 of the stack module 200 may be an automotive fuel cell powertrain. Fuel cell powertrains that drive a fuel cell vehicle may be connected and used as a power generation fuel cell. The stack module 200 may be configured by stacking the automotive fuel cell powertrains.

Since vehicles are driven in various environments, there is a high possibility of performance deterioration of an automotive fuel cell in comparison to a power generation fuel cell. Since it is possible to mount and use an automotive fuel cell having performance decreased below a predetermined level from the initial performance in the stack module 200, there is an effect that energy efficiency may be increased, since it is possible to use a dead automotive fuel cell powertrain, for power generation, it is possible to secure additional life span of the fuel cell. When automotive fuel cell powertrains are used, the frame 220 may be used as a dedicated frame 220 for connection, so connection is possible merely through a simple connection.

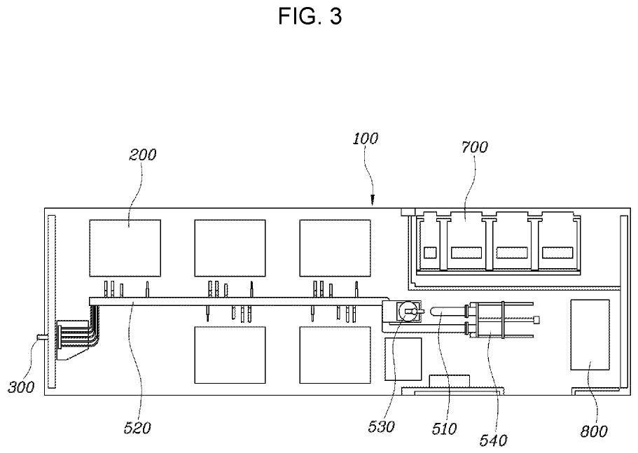

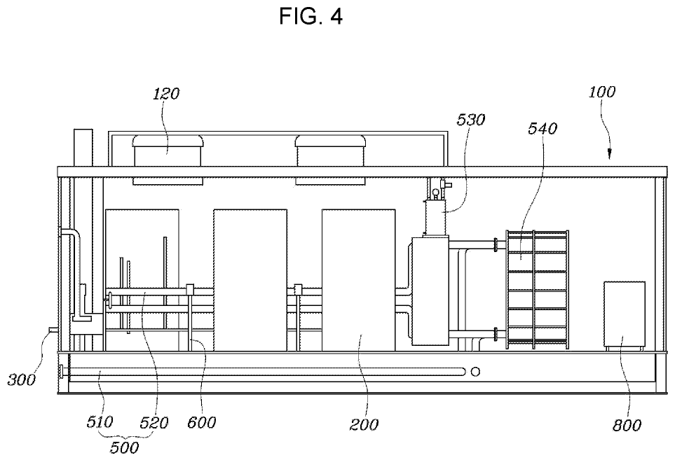

FIG. 3 and FIG. 4 are views showing the inside of the container 100 of the container type power generation fuel cell system according to various exemplary embodiments of the present invention. FIG. 3 shows the container 100 seen from above and FIG. 4 shows the container 100 seen from a side thereof.

Referring to FIG. 3 and FIG. 4, the container type power generation fuel cell system according to various exemplary embodiments of the present invention may include a fuel supply line 300, an exhaust line 400, a cooling fluid circulation line 500, a power converter 700, and a controller 800.

The fuel supply line 300 is a channel connected to the fuel cell stacks 210 of the stack module 200 to supply hydrogen and air. The fuel supply line 300 is connected to a fuel supply outside the container 100 and is inserted into the container 100 and connected to the fuel cell stacks 210, whereby fuel gas may be supplied.

The exhaust line 400 is a channel through which exhaust gas produced by the fuel cell stacks 210 flows. The exhaust gas is fuel gas remaining after a reaction in the fuel cell stacks 210.

The fuel cell system is supplied with a larger amount of fuel gas than the actual reaction amount in consideration of activation of the fuel cell stack 210, reaction loss, and internal resistance loss. Since cells are stacked in the fuel cell stack 210, chemical reaction of 100% does not occur and a larger amount of fuel gas than an equivalent theoretically required for reaction is supplied in consideration of appropriate flow speed, distribution, etc. of the fuel gas passing through the cells and the flow resistance in a manifold. Accordingly, the fuel gas remaining after reaction in the fuel cell stacks 210 is discharged outside through the exhaust line 400.

The cooling fluid circulation line 500 is a channel through which cooling fluid flows. The cooling fluid circulation line 500 is connected to the fuel cell stacks 210 for heat change. The reaction occurring in the fuel cell stack 210 is an exothermic reaction, so that the temperature of the fuel cell stack 210 is increased by the reaction. The cooling fluid flowing through the cooling fluid circulation line 500 exchanges heat with the fuel cell stack 210, being able to control the temperature of the fuel cell stack 210.

The cooling fluid circulation line 500 may include an internal circulation line 520 circulating in the container 100 and an external circulation line 510 circulating outside the container 100. The internal circulation line 520 is connected to the fuel cell stacks 210 of the stack module 200 to exchange heat with the fuel cell stacks 210. The external circulation line 510 is connected to the internal circulation line 520, provided as a channel for supplying cooling fluid to the container 100 or discharging the cooling fluid.

A heat exchanger 540 may be mounted in the cooling fluid circulation line 500. The heat exchanger 540 can cool cooling fluid increased in temperature. The cooled cooling fluid can exchange heat again with the fuel cell stack 210 through the cooling fluid circulation line 500.

An expansion tank 530 may also be mounted in the cooling fluid circulation line 500. The expansion tank 530 can prevent an increase in pressure due to thermal expansion of the cooling fluid. Accordingly, the cooling fluid is maintained at predetermined pressure during the operation of the system.

The power converter 700 is a device changing the output voltage of the stack module 200 from DC to AC to supply the output voltage. Referring to FIG. 3, since the power converter 700 is a high-capacity electric device, it may be isolated by a partition in the container 100 to prevent explosion.

The controller 800 is a device controlling the power generation system in the container 100. The controller 800 is electrically connected to the stack module 200, the anti-explosion fan 120, the fuel supply line 300, the cooling fluid circulation line 500, and the power converter 700 and detects and controls the states of these components. The controller 800 can selectively operate the stack modules 200 by controlling the stack modules 200. An inverter 710 may be connected to convert DC voltage into AC voltage for each of the stack modules 200, and an incoming panel 900 may be provided.

The container type power generation fuel cell system according to various exemplary embodiments of the present invention may further include a terminal block 600. Referring to FIG. 4, the terminal block 600 may be mounted as a stand type in the container 100. The power produced by the fuel cell stacks 210 of a stack module 200 is combined and converted by the inverter 710. The terminal block 600 is mounted at the intersection of wires to send power to a corresponding inverter 710 from a stack module 200, so that the wires may be combined. Furthermore, communication lines connected to the stack modules 200 or the power converter 700 from the controller 800 may be mounted in appropriate paths by the terminal block 600. The internal space may be efficiently managed by the terminal block 600.

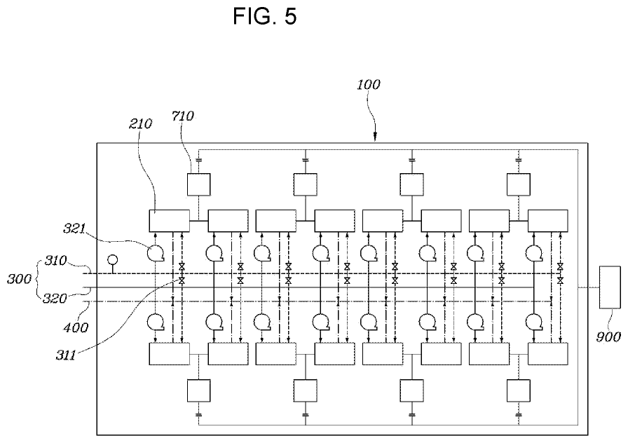

FIG. 5 is a view showing the connection relationship in the container type power generation fuel cell system according to various exemplary embodiments of the present invention.

Referring to FIG. 5, a plurality of stack modules 200 may be electrically connected to each other in series. It is important to maintain the temperature of the stack modules 200 at a predetermined level by use of the stack modules 200 within the rated power to improve the stability and reliability of the fuel cell power generation system. To this end, the stack modules 200 are connected in parallel to each other. A parallel operation configuration in a large-capacity power generation system can simplify the overall control and uniformly distribute a load, so that the rated power may be maintained. Accordingly, it is possible to secure a potential difference by connecting the fuel cell stacks 210 in series in the stack module 200 and to secure stability of the system by connecting the stack modules 200 in parallel to each other.

As shown in FIG. 5, the fuel supply line 300 may include a hydrogen supply line 310 and an air supply line 320. The hydrogen supply line 310 is a channel for supplying hydrogen to the fuel cell stacks 210 and the air supply line 320 is a channel for supplying air to the fuel cell stacks 210.

A valve 311 controlling the flow rate of hydrogen may be mounted in the hydrogen supply line 310. The valve 311 can control the flow rate of hydrogen that flows into the fuel cell stacks 210, and can stop supply of hydrogen, if necessary. Optimal control is possible by controlling the flow rate of hydrogen which is fuel gas in accordance with the load in the system. The valve 311 is electrically connected to the controller 800, so it may be controlled by the controller 800.

On the other hand, a blower 321 may be mounted in the air supply line 320. Air may be supplied to the container type power generation fuel cell system according to various exemplary embodiments of the present invention in two methods. The first one is a method of supplying external air, which flows inside through the fuel supply line 300, directly to the fuel cell stacks 210 and the second one is a method of supplying the air in the container 100 to the fuel cell stacks 210. The blower 321 may be mounted in the air supply line 320 to supply the air in the container 100 to the fuel cell stacks 210.

Furthermore, two or more containers 100 may be connected and integrally managed in the container type power generation fuel cell system according to various exemplary embodiments of the present invention. A controller 800 provided for one container 100 may be connected to one or more containers 100, being able to control a plurality of containers 100 with one controller 800. Since a plurality of containers 100 forms one system, a system that can produce a large amount of power may be constructed.

In addition, the term “controller” refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The controller according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors.

The controller may be at least one microprocessor operated by a predetermined program which may include a series of commands for carrying out a method in accordance with various exemplary embodiments of the present invention.

The aforementioned invention can also be embodied as computer readable codes on a computer readable recording medium. The computer readable recording medium is any data storage device that can store data which can be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc. and implementation as carrier waves (e.g., transmission over the Internet).

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A power generation fuel cell system comprising:
a container having a door in a first side of the container or the first side and a second side of the container;
a plurality of stack modules mounted in the container and each having fuel cell stacks stacked and separately connected to each other in an attachable/detachable manner;
a fuel supply line connected to a fuel supply outside the container, inserted into the container, and connected to the fuel cell stacks to supply hydrogen and air that are fuel gases;
an exhaust line forming a channel through which exhaust gas produced by the fuel cell stacks flow to discharge the exhaust gas outside the container;
a cooling fluid circulation line connected to the fuel cell stacks to exchange heat and passing cooling fluid therethrough; and
a power converter converting DC voltage produced by the plurality of stack modules into AC voltage,
wherein the plurality of stack modules is integrally managed by a controller.

2. The power generation fuel cell system of claim 1, wherein the fuel cell stacks are automotive fuel cell powertrains.

3. The power generation fuel cell system of claim 1, wherein each of the plurality of stack modules has a frame in which each of the fuel cell stacks is stacked, and the frames in the plurality of stack modules is connected to each other.

4. The power generation fuel cell system of claim 1, wherein the fuel cell stacks are connected in series to each other.

5. The power generation fuel cell system of claim 1, wherein the plurality of stack modules is connected in parallel to each other.

6. The power generation fuel cell system of claim 1, further including the controller electrically connected to the plurality of stack modules, the fuel supply line, the cooling fluid circulation line, and the power converter to detect states of the plurality of stack modules, the fuel supply line, the cooling fluid circulation line, and the power converter and control operations of the plurality of stack modules, the fuel supply line, the cooling fluid circulation line, and the power converter, and selectively controlling the plurality of stack modules.

7. The power generation fuel cell system of claim 6, wherein the controller is connected to one or more containers and is configured to integrally control a plurality of containers including the one or more containers.

8. The power generation fuel cell system of claim 1, wherein the cooling fluid circulation line includes an expansion tank that maintains pressure of cooling fluid at a predetermined level.

9. The power generation fuel cell system of claim 1, wherein an anti-explosion fan conditioning air in the container is mounted outside the container.

10. The power generation fuel cell system of claim 1, wherein the fuel supply line includes a hydrogen supply line for supplying the hydrogen to the fuel cell stacks and an air supply line for supplying air to the fuel cell stacks, and a valve controlling a flow rate of the hydrogen is mounted in the hydrogen supply line.

11. The power generation fuel cell system of claim 10, wherein the air supply line includes a blower sending the air into the fuel cell stacks.

12. The power generation fuel cell system of claim 1, wherein a heat exchanger for cooling a cooling fluid is mounted in the cooling fluid circulation line.

13. The power generation fuel cell system of claim 1, further including a terminal block mounted in the container, connecting different wires, and determining paths of the different wires.

14. The power generation fuel cell system of claim 13, wherein the terminal block is mounted at an intersection of the different wires to send power to a corresponding inverter from the plurality of stack modules.
